(19) United States
(12) Patent Application Publication
(10) Pub. No.: US 2010/0060486 A1
(43) Pub. Date: Mar. 11, 2010

(54) PARKING ASSIST APPARATUS

(75) Inventors: Yutaka NAKASHIMA, Kariya-shi (JP); Kazunori SHIMAZAKI, Kariya-shi (JP); Tomio KIMURA, Kariya-shi (JP); Koji HIKA, Kariya-shi (JP)

Correspondence Address: Locke Lord Bissell & Liddell LLP;Attn: IP Docketing, Three World Financial Center, New York, NY, 10281-2101, US

(73) Assignee: KABUSHIKI KAISHA TOYOTA JIDOSHOKKI, Aichi-ken (JP)

(21) Appl. No.: 12/556,157

(22) Filed: Sep. 9, 2009

(30) Foreign Application Priority Data
Sep. 9, 2008 (JP) 2008-230816

(51) Int. Cl. G08G 1/14

(52) U.S. Cl. 340/932.2

(57) ABSTRACT

A parking assist apparatus has a camera for capturing an image of a mark from a vehicle, wherein the mark is fixed to a parking area with a predetermined positional relation to the parking area and has a predetermined figure, and the vehicle is supposed to park in the parking area. The parking assist apparatus further has a vehicle-position detecting device for detecting a position of the vehicle based on the image of the mark captured by the camera and outputting a position data of the vehicle, a vehicle position data-storing device for storing the position data of the vehicle, a data acquisition device for acquiring attribute data of the parking area and the vicinities of the parking area; and a vehicle guide device for guiding the vehicle in moving out of the parking area, based on the position data of the vehicle in the parking area stored in the vehicle position data-storing device and the attribute data of the parking area and the vicinities of the parking area given by the data acquisition device.

### BACKGROUND OF THE INVENTION

The present invention relates to a parking assist apparatus, and more particularly to an apparatus for assisting in moving a vehicle out of a parking area such as a garage.

A parking assist apparatus for assisting the driver in moving a vehicle out of a garage is disclosed in Japanese Patent Application Publications 2008-12987 and 2007-62625. According to the apparatus of the former Publication, when the driver backs a vehicle out from a parking area, a method for moving the vehicle out of the parking area, including information about the direction in which the vehicle should be turned in backing movement, is calculated based on stored information of the path along which the vehicle was moved to be parked in the parking area, the space around the vehicle and the vehicle dimensions. According to the apparatus of the latter Publication, data of vehicle path based on the steering angle of each wheel of the vehicle and the turning of the vehicle during its parking movement is stored in memory, and the operation of actuator and wheel drive device of the assist apparatus is so controlled that the vehicle is moved out of the parking area along the path stored in memory.

In the parking assist apparatuses of the above Publications according to which the parking assistance in moving the vehicle out of the parking area is performed by making use of the vehicle path generated during parking the vehicle into the parking area, however, it is difficult to assist properly in moving the vehicle out of the parking area in a case where an unskilled driver had to repeat steering operations to park the vehicle or parked the vehicle while avoiding an obstacle.

The present invention is directed to solving the above problem by providing a parking assist apparatus for assisting a vehicle driver in moving a vehicle properly out of a parking area.

### SUMMARY OF THE INVENTION

A parking assist apparatus has a camera for capturing an image of a mark from a vehicle, wherein the mark is fixed to a parking area with a predetermined positional relation to the parking area and has a predetermined figure, and the vehicle is supposed to park in the parking area. The parking assist apparatus further has a vehicle-position detecting device for detecting a position of the vehicle based on the image of the mark captured by the camera and outputting a position data of the vehicle, a vehicle position data-storing device for storing the position data of the vehicle, a data acquisition device for acquiring attribute data of the parking area and the vicinities of the parking area; and a vehicle guide device for guiding the vehicle in moving out of the parking area, based on the position data of the vehicle in the parking area stored in the vehicle position data-storing device and the attribute data of the parking area and the vicinities of the parking area given by the data acquisition device.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is a plan view of a vehicle equipped with a parking assist apparatus and a parking area for the vehicle according to a first embodiment of the present invention;

FIG. 2 is a plan view of a mark used in the first embodiment;

FIG. 3 is a schematic configuration diagram showing various devices of the parking assist apparatus according to the first embodiment;

FIG. 4 is a schematic configuration diagram showing various devices of a parking assist apparatus according to a second embodiment; and

FIGS. 5A and 5B are plan views showing a vehicle and a parking area and describing a modification in parking a vehicle in a parking area and moving the vehicle out of the parking area over the first and second embodiments.

### DETAILED DESCRIPTION OF THE PREFERRED EMBODIMENTS

### First Embodiment

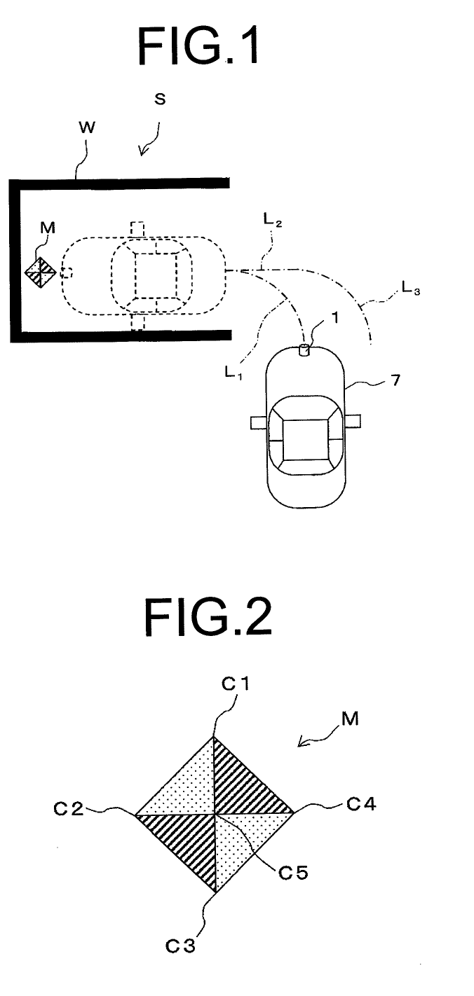

First and second embodiments according to the present invention will now be described with reference to FIGS. 1 through 5.

A vehicle 7 equipped with a parking assist apparatus 100 and a parking area S for the vehicle 7 according to the first embodiment is shown in plan view in FIG. 1. A rectangular parking area having walls on three sides thereof is designated by symbol S and a mark M indicative of various information about the parking area S is set on the floor of the parking area S. The vehicle 7 is equipped with a camera 1 for capturing the image of the mark M. The following will describe a case in which a driver parks the vehicle 7 in the parking area S by driving the vehicle forward and backs the vehicle to move out therefrom. Therefore, the camera 1 is installed in the front of the vehicle 7.

The mark M is fixed at a predetermined position in the parking area S so that the positional relation of the mark M to the parking area S is known. The mark M may be, for example, of a square-shaped figure formed by four isosceles right triangles connected each other, as shown in FIG. 2. Any two adjacent isosceles right triangles are coded by different colors and the mark M has five feature points, C1 through C5 which are determined by the intersection points of the sides of the isosceles right triangles, as shown in FIG. 2.

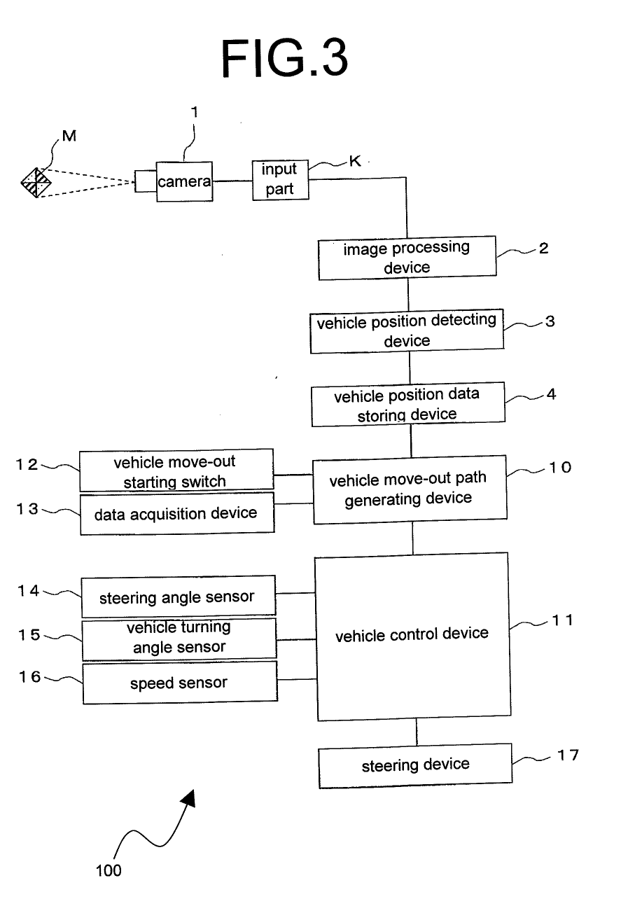

As shown in FIG. 3, the camera 1 is connected to an input part K. The input part K is connected to an image-processing device 2 that extracts the feature points from an image of the mark M captured by the camera 1 and recognizes them on the image in two-dimensional coordinate. The image-processing device 2 is connected to a vehicle-position detecting device 3 that calculates the position of the camera 1 based on the position of the mark M, i.e., the position data of the vehicle 7 in the parking area S. The vehicle-position detecting device 3 is connected to a vehicle position data-storing device 4 for storing the position data of the vehicle 7. The vehicle position data-storing device 4 may be adapted to store all position data of the vehicle 7 being moved to be parked in the parking area S, i.e., data of the path of the vehicle 7 being parked, or of the position data of the vehicle 7 when a switch (not shown) is activated or the engine of the vehicle 7 is stopped. The vehicle position data-storing device 4 may store at least the parking position data of the vehicle 7 in the parking area S.

The vehicle position data-storing device 4 is connected to a vehicle move-out path-generating device 10 as a vehicle guide device for generating a path for moving the vehicle out of the parking area S. The vehicle move-out path-generating device 10 is connected to a vehicle move-out starting switch 12 and to a data acquisition device 13. The vehicle move-out starting switch 12 is activated by the driver when he desires to move the vehicle 7 out of the parking area S. The data acquisition device 13 retrieves and acquires attribute data of the parking area S and its vicinities (e.g., parking area size and shape, its surrounding area size and shape) from a memory storing therein such data. The vehicle move-out path-generating device 10 is also connected to a vehicle control device 11 as a vehicle guide device. The vehicle control device 11 is connected to a steering angle sensor 14, a vehicle turning angle sensor 15, a speed sensor 16 and a steering device 17. The vehicle move-out path-generating device 10 and the vehicle control device 11 cooperate to function as the vehicle guide device.

The following will describe the operation of the parking assist apparatus 100 of the first embodiment. As shown in FIG. 1, the driver parks the vehicle 7 in the parking area S by driving the vehicle 7 forward. The camera 1 mounted at the front of the vehicle 7 captures the image of the mark M while the vehicle 7 is being parked in the parking area S. The image captured is inputted to the image-processing device 2 through the input part K. The image-processing device 2 extracts five feature points C1 through C5 from the image of the mark M captured by the camera 1 and recognizes them on the image in two-dimensional coordinate. Based on the five feature points C1 through C5 in two-dimensional coordinate recognized by the image-processing device 2, the vehicle-position detecting device 3 calculates six positional parameters of the camera 1, i.e., three-dimensional coordinate (x,y,z), a tilting angle (depression angle), a panning angle (direction angle), a swing angle (rotation angle), based on the mark M, respectively.

The following will describe the method for calculating the positional parameters by the vehicle-position detecting device 3. Suppose that the position on the ground surface at which a line extending vertically from the center of the rear axle of the vehicle 7 intersects with the ground surface is the origin O of ground surface coordinate system having x-axis and y-axis in horizontal directions and z-axis in vertical direction. Also suppose that there is an image coordinate system, i.e., X-axis and Y-axis on the image captured by the camera 1. The coordinate values, Xm and Ym (m=1-5) of the feature points C1 through C5 of the mark M on the image coordinate system are expressed by the six positional parameters of the feature points C1 through C5 of the mark M in the ground surface coordinate system, i.e., the coordinate values, xm, ym, zm, the aforementioned angle parameters, Kn (n=1-3), the tilt angle, the panning angle, the swing angle, using functions F, G, as follows:

Xm=F(xm,ym,zm,Kn)+DXm

Ym=G(xm,ym,zm,Kn)+DYm

wherein DXm and DYm are deviations between X, Y coordinates of the feature points, C1 through C5 calculated by the functions, F, G and Xm, Ym coordinate values of the feature points, C1 through C5 recognized by the image-processing device 2, respectively.

In other words, ten relational expressions are formed for the six positional parameters (xm, ym, zm, Kn) by expressing five feature points, C1 through C5 in X, Y-axes, respectively. Then the positional parameters (xm, ym, zm, Kn) are found so as to minimize the square sum for the deviations DXm, DYm, i.e., S=Σ(DXm²+DYm²). Eventually, an optimization problem is solved to minimize S. Commonly known optimization method such as simplex method, steepest descent method, Newton method, quasi-Newton method and the like may be used.

Since the positional parameters are decided by forming more than six relational expressions, wherein “six” is the number of the positional parameters (xm, ym, zm, Kn) to be calculated, the positional parameters (xm, ym, zm, Kn) are found more precisely. In the first embodiment, ten relational equations are generated for the six positional parameters (xm, ym, zm, Kn) by five feature points, C1 through C5. However, if the number of relational equations is more than or equal to the number of positional parameters (xm, ym, zm, Kn) to be calculated, the positional parameters can be obtained. Therefore, six positional parameters (xm, ym, zm, Kn) can be calculated as long as six relational equations are formed by at least three feature points.

Making use of the calculated positional parameters of the camera 1, the vehicle-position detecting device 3 determines the positional relation between the vehicle 7 and the parking area S. That is, the positional relation between the camera 1 and the parking area S can be specified based on the positional parameters calculated by the vehicle-position detecting device 3 and the known positional relation between the mark M and the parking area S. Since the positional relation between the camera 1 and the vehicle 7 is known, the positional relation between the vehicle 7 and the parking area S may be specified. After the driver has completed parking the vehicle 7 in the parking area S, the driver stops the engine of the vehicle 7. The vehicle position data-storing device 4 is operated automatically subsequently to the above stop of the engine or by the driver activating any switch (not shown) to store the parking position data of the vehicle 7 in the parking area S.

If the driver desires the leading of the vehicle 7 by the parking assist apparatus when the driver moves the vehicle 7 out of the parking area S, he activates the vehicle move-out starting switch 12. Accordingly, the vehicle move-out path-generating device 10 retrieves the attribute data of the parking area S and its vicinities acquired by the data acquisition device 13 and also the parking position data of the vehicle 7 in the parking area S stored in the vehicle position data-storing device 4 when the driver parked vehicle 7 into the parking area S. The vehicle move-out path-generating device 10 generates a path for the vehicle 7 to move out of the parking area S based on the parking position data of the vehicle 7 and the above-described relevant data so that the driver can move the vehicle 7 out of the parking area S.

When moving out of the parking area S the vehicle 7 which was parked while being driven by the drive forward into the parking area S as in the first embodiment, the driver can move the vehicle 7 out of the parking area S by tracing a circular path L1 (refer to FIG. 1) with an appropriate radius. The vehicle move-out path-generating device 10 generates the circular path L1 based on the parking position data of the vehicle 7 and the above-described relevant data so that the driver can move the vehicle 7 out of the parking area S without causing the vehicle 7 to bump into the wall W of the parking area S. However, when the driver can not move the vehicle 7 out of the parking area S only by tracing the circular path, e.g., because the vehicle 7 was parked very close to one of the walls W of the parking area S, the vehicle move-out path-generating device 10 generates a linear path L2 before generating the circular path (refer to FIG. 1), i.e., a combination of the linear path L2 and the circular path L3 with an appropriate radius (refer to FIG. 1).

In starting to move the vehicle 7 out of the parking area S, the vehicle control device 11 sends information about driving operation to the steering device 17 for driving the vehicle 7 along the path generated by the vehicle move-out path-generating device 10. The vehicle control device 11 simultaneously recognizes an actual path based on signals sent by the steering angle sensor 14, the vehicle turning angle sensor 15 and the speed sensor 16 and compares the actual path with the path generated by the vehicle move-out path-generating device 10. When the actual path fails to coincide with the path generated by the vehicle move-out path-generating device 10, the vehicle control device 11 sends a warning signal and the like to the steering device 17. The steering device 17 may include an audio speaker or a buzzer that provides the driver with any information including warning or alarm. The steering device 17 may further include a display or a lamp that visually provides the driver with the same information as in the case of the audio device. Furthermore, the steering device 17 may be provided by a vibrator and the like.

When the vehicle 7 reaches the end of the path generated by the vehicle move-out path-generating device 10, the parking assist apparatus 100 determines that the driver has completed moving the vehicle 7 out of the parking area S, thus completing leading the vehicle in moving out of the parking area S. Judgment on whether the driver has completed moving the vehicle 7 out of the parking area S is not limited to the above case, but the same judgement may be made when the vehicle 7 has completely moved out of the parking area S or when the vehicle has entered completely into an area located in front of the parking area S or when a combination of such judgments has been fulfilled.

Thus, the camera 1 takes an image of the mark M which has a given shape and is fixed to a specified position with a known positional relation to the parking area S. Based on the image thus captured, the parking position data of the vehicle 7 in the parking area S is stored in memory. Subsequently, the path along which the vehicle 7 should be moved out of the parking area S is generated based on the parking position data of the vehicle 7 and also the attribute data of the parking area S and its vicinities. Thus, the driver can move the vehicle 7 out of the parking area S properly with the aid of the parking assist apparatus 100 based on the generated path.

The move-out path generated in the first embodiment is either a circular path or a combination of a linear path and a circular path. However, the move-out path is not limited to such paths. When the parking area S is small, the driver needs to repeat steering operation of the vehicle 7, or when the area surrounding the parking area S is small, the vehicle 7 may need to follow a combination of plural circular paths with different radii of curvatures because a long linear path can not be generated due to the limited area surrounding the parking area S. The method of generating a path for moving the vehicle 7 out of the parking area S is only described based on a simple case in the first embodiment. As long as the move-out path is generated based on the parking position data of the vehicle 7 and the attribute data of the parking area S and its vicinities, any move-out path may be generated.

### Second Embodiment

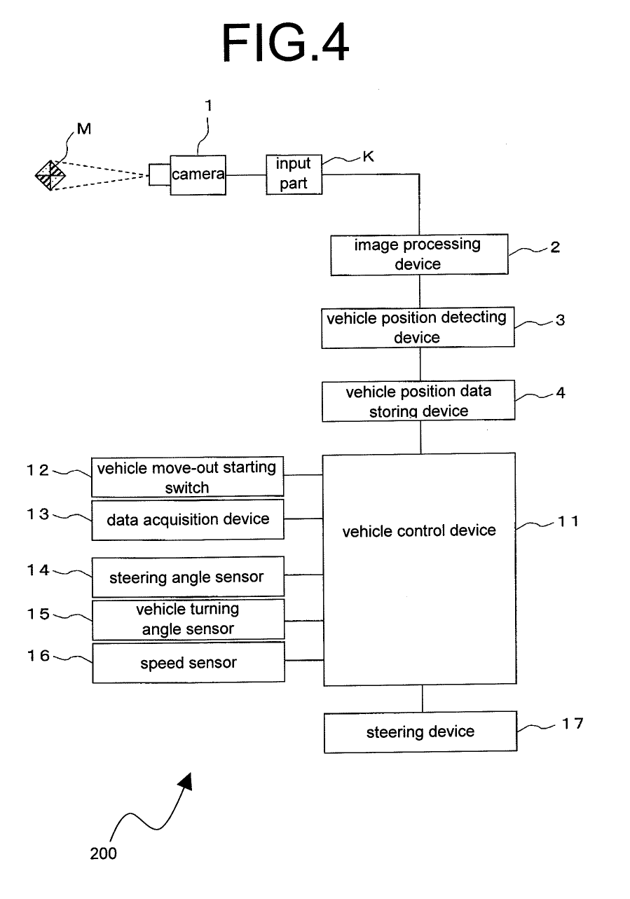

The following will describe the second embodiment of the present invention. The following description will use the same reference numbers for the common elements or components in both embodiments, and the description of such elements or components in FIGS. 1 through 3 for the second embodiment will be omitted. The parking assist apparatus 200 according to the second embodiment differs from the counterpart 100 of the first embodiment in that the vehicle move-out path-generating device 10 is omitted. As shown in FIG. 4, the vehicle move-out starting switch 12 and the data acquisition device 13 are connected to the vehicle control device 11 as the vehicle guide device. The vehicle control device 11 functions as the vehicle guide device. The other components and devices are substantially identical to their counterparts of the first embodiment.

The operations of the parking assist apparatus 200 are the same as those of the first embodiment until the parking position data of the vehicle 7 in the parking area S is stored in the vehicle position data-storing device 4 after the driver has parked the vehicle 7 in the parking area S. When the driver activates the vehicle move-out starting switch 12 in moving the vehicle 7 out of the parking area S, the vehicle control device 11 retrieves the parking position data of the vehicle 7 in the parking area S and the attribute data of the parking area S and its vicinities acquired by the data acquisition device 13. When the vehicle 7 has been parked in the parking area S, the parking position data of the vehicle 7 is stored in the vehicle position data-storing device 4. Based on the parking position data of the vehicle 7 and the attribute data of the parking area and its vicinities, the vehicle control device 11 calculates a safe area in which the driver can safely move the vehicle 7 out of the parking area S without causing the vehicle 7 to bump into the wall W and the like of the parking area S. Based on the signals sent by the steering angle sensor 14, the vehicle turning angle sensor 15 and the speed sensor 16, the vehicle control device 11 then recognizes the actual move-out path of the vehicle 7 and in the meantime judges whether the vehicle 7 is within the safe area or not. When the vehicle 7 is about to move out of the safe area, the vehicle control device 11 causes the steering device 17 to send a warning signal. It is judged that the driver has completed moving the vehicle 7 out of the parking area S when the vehicle 7 has moved out of the parking area S completely or when the vehicle 7 has entered completely into an area located in front of the parking area S or when a combination of such judgments has been fulfilled.

Thus, unlike the first embodiment, the move-out path for moving the vehicle 7 out of the parking area S is not generated based on the parking position data of the vehicle 7 in the parking area S and the relevant data of the parking area S and its vicinities. In the second embodiment, the safe area is calculated based on the above data so that the driver can safely move the vehicle 7 out of the parking area S without causing the vehicle 7 to bump into the wall W and the like thereof, and when the vehicle 7 has moved out of the safe area, the steering device 11 sends a warning signal, so that the same advantageous effects as those in the first embodiment can be obtained. By specifying the position of the vehicle 7 based on the mark M when the driver has parked the vehicle 7 in the parking area S, the final parking position data of the vehicle 7 in relation to the parking area S and its vicinities is very precisely specified, with the result that a warning signal can be sent with high degree of accuracy when the vehicle 7 is moved out of the parking area S.

In the first and second embodiments, the recognition of the actual move-out path is made based on the signals sent by the steering angle sensor 14, the vehicle turning angle sensor 15 and the speed sensor 16, but the present invention is not limited to these embodiments. The actual move-out path may be recognized by capturing the image of the mark M as in the case of capturing the image of the mark M in parking the vehicle 7 in the parking area S, without using the steering angle sensor 14, the vehicle turning angle sensor 15 and the speed sensor 16.

In the first and second embodiments, each of the image-processing device 2, the vehicle position-detecting device 3, the vehicle position data-storing device 4, the vehicle move-out path-generating device 10, the vehicle control device 11, the data acquisition device 13 and the vehicle guide device is realized by software, however, each of them may be realized as an individual hardware part.

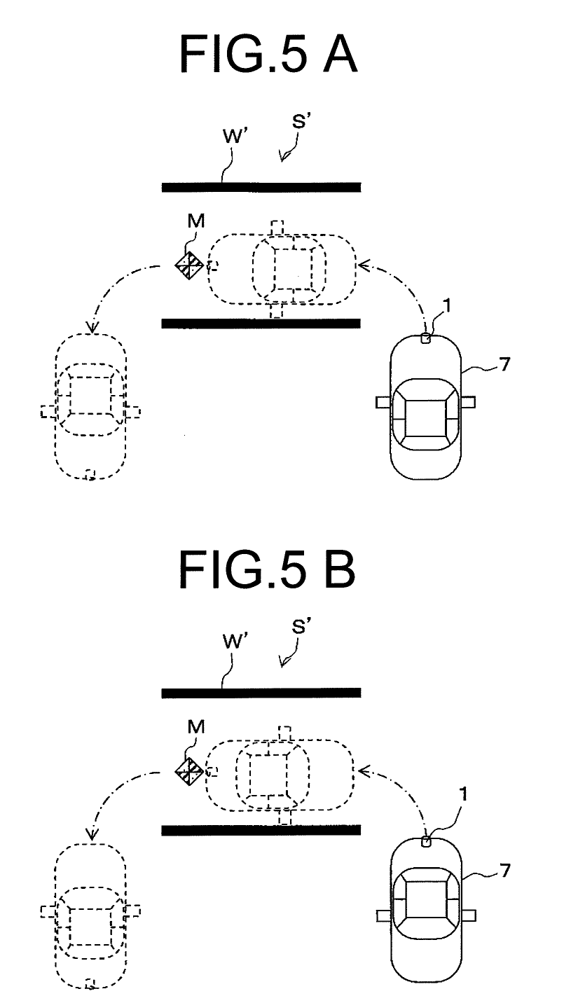

In the first and second embodiments, the driver parks the vehicle 7 by driving the vehicle 7 forward into the parking area S and backs the vehicle 7 out thereof in case of moving the vehicle 7 out of the parking area S. The present invention is not limited to these embodiments. When parking the vehicle 7 in the parking area S as shown in FIG. 1, the vehicle 7 may be parked in the parking area S while being moved backward and may move the vehicle 7 out of the parking area S while being moved forward. According to the present invention, when parking the vehicle 7 in the parking area S′ with two parallel side walls W′ as shown in FIGS. 5A and 5B, the driver may park the vehicle 7 in the parking area S′ and move the vehicle 7 out thereof while moving the vehicle 7 forward in both cases as shown in FIG. 5A, or moving the vehicle 7 backward in both cases as shown in FIG. 5B. In these cases of FIGS. 5A and 5B, the camera 1 may be installed at a different position of the vehicle 7 or plural cameras may be installed.

In the first and second embodiments, the attribute data of the parking area S and its vicinities are stored in the data acquisition device 13 in advance. The present invention is not limited to these embodiments. In the structure in which a move-out path for moving the vehicle out of the parking area is generated before or during the parking operation of the vehicle 7, as described in the first embodiment, the data acquisition device 13 may obtain the necessary data via communication before generating the move-out path and the vehicle 7 may be moved out of the parking area based on the data thus obtained and the parking position data of the vehicle 7.

What is claimed is:

1. A parking assist apparatus comprising:
a camera for capturing an image of a mark from a vehicle, wherein the mark is fixed to a parking area with a predetermined positional relation to the parking area and has a predetermined figure, and the vehicle is supposed to park in the parking area;
a vehicle-position detecting device for detecting a position of the vehicle based on the image of the mark captured by the camera and outputting a position data of the vehicle;
a vehicle position data-storing device for storing the position data of the vehicle;
a data acquisition device for acquiring attribute data of the parking area and the vicinities of the parking area; and
a vehicle guide device for guiding the vehicle in moving out of the parking area, based on the position data of the vehicle in the parking area stored in the vehicle position data-storing device and the attribute data of the parking area and the vicinities of the parking area given by the data acquisition device.

2. The parking assist apparatus according to claim 1, wherein
the vehicle guide device includes;
a vehicle move-out path-generating device for generating a path for moving the vehicle out of the parking area, based on the position data of the vehicle in the parking area stored in the vehicle position data-storing device and the attribute data of the parking area and the vicinities of the parking area given by the data acquisition device, wherein
the vehicle guide device guides the vehicle in moving out of the parking area, based on the path.

3. The parking assist apparatus according to claim 2, wherein
the path generated by the vehicle move-out path-generating device includes a circular shape.

4. The parking assist apparatus according to claim 3, wherein
the path generated by the vehicle move-out path-generating device includes a linear shape before generating the path including the circular shape.

5. The parking assistance device according to claim 2, wherein
the vehicle guide device includes:
a vehicle control device for recognizing an actual path for the vehicle, wherein
the vehicle control device compares the actual path with the path generated by the vehicle move-out path-generating device, and generates an warning signal when the actual path fails to coincide with the path generated by the vehicle move-out path-generating device.

6. The parking assist apparatus according to claim 5, wherein
the vehicle control device is connected to a steering sensor, a vehicle turning angle sensor and a speed sensor and the actual path is recognized based on signals of the steering sensor, the vehicle turning angle sensor and the speed sensor.

7. The parking assist apparatus according to claim 1, wherein
the vehicle guide device includes:
a vehicle control device for generating an actual path for the vehicle, wherein
the vehicle control device calculates a safe area in which the driver can safely move the vehicle out of the parking area, based on the position data of the vehicle in the parking area and the attribute data of the parking area and the vicinities of the parking area, and generates an warning signal when the vehicle gets out of the safe area.

8. The parking assist apparatus according to claim 1, wherein
the mark has a square-shaped figure formed by four isosceles right triangles connected each other and any two adjacent isosceles right triangles are coded by different colors thereby to have five feature points.

9. The parking assist apparatus according to claim 8, wherein
the vehicle-position detecting device specifies a positional relation between the vehicle and the parking area based on the five feature points.

10. The parking assist apparatus according to claim 1, wherein
the attribute data of the parking area and the vicinities of the parking area are sizes and shapes of the parking area and the vicinities of the parking area, respectively.
